(19) United States
(12) Patent Application Publication
(10) Pub. No.: US 2007/0130335 A1
(43) Pub. Date: Jun. 7, 2007

(54) Advertisement Validation

(75) Inventor: Phillipe A. Loher, Lowell, MA (US)

Correspondence Address: CUENOT & FORSYTHE, L.L.C., 12230 FOREST HILL BLVD., STE. 120, WELLINGTON, FL, 33414, US

(73) Assignee: International Business Machines Corporation, Armonk, NY (US)

(21) Appl. No.: 11/164,708

(22) Filed: Dec. 2, 2005

(51) Int. Cl. G06F 15/173

(52) U.S. Cl. 709/225

(57) ABSTRACT

A method and a system for advertising over a network. The method can include forwarding to a client a first advertisement that includes a first pass code. The advertisement can be formatted in accordance with a first format. A user of the client can be prompted to enter a second pass code corresponding to the first pass code. If the second pass code is received from the client and the second pass code corresponds to the first pass code, requested network resources can be forwarded to the client.

### FIELD OF THE INVENTION

The present invention relates to Internet communications and, more particularly, Internet advertising.

### BACKGROUND OF THE INVENTION

In recent years the Internet has emerged as a medium for marketing and advertising that is different from other advertising mediums. The Internet can serve not only as a communications channel, but also as a transaction and distribution channel. For instance, consumers can receive information about products and services, and make purchases and payments all through the Internet. The Internet has therefore become an integral part of the media mix for many advertisers, and new forms of advertising have filled the Internet. Examples of such advertising include animated banner ads, sponsor logos, interstitials, advertorials, advertainment, and 3-D visualization. Popup blockers which effectively disable many of such Internet advertisements now are prevalent, however. In consequence, Internet advertisements reach only a portion of their intended audience. Moreover, such advertisements have become so prevalent that users are essentially being conditioned to ignore them. Thus, the value of such forms of advertising has become tenuous.

It therefore would be beneficial to provide a technique that increases the effective distribution of Internet advertisements.

### SUMMARY OF THE INVENTION

The present invention relates to a method for advertising over a network. The method can include forwarding to a client a first advertisement that includes a first pass code. The advertisement can be formatted in accordance with a first format. A user of the client can be prompted to enter a second pass code corresponding to the first pass code. If the second pass code is received from the client and the second pass code corresponds to the first pass code, requested network resources can be forwarded to the client.

The present invention relates to a system for advertising over a network. The system can include a server that forwards to a client a first advertisement comprising a first pass code, the advertisement being formatted in accordance with a first format. The server also can prompt a user of the client to enter a second pass code corresponding to the first pass code. If the second pass code is received from the client and the second pass code corresponds to the first pass code, the server can forward requested network resources to the client.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 is a block diagram illustrating a system for presenting Internet based advertisements in accordance with one embodiment of the present invention.

FIG. 2 is a pictorial illustration of a graphical user interface presenting an Internet based advertisement in accordance with an embodiment of the present invention.

FIG. 3 is a pictorial illustration of a graphical user interface presenting a prompt to enter a pass code in accordance with another embodiment of the present invention.
FIG. 4 is a flowchart illustrating one aspect of presenting Internet advertisements in accordance with the inventive arrangements disclosed herein.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The embodiments disclosed herein relate to a method and a system for presenting Internet based advertisements to users in a manner that increases their effectiveness. For example, in response to a user navigating to a particular web site, the web site can present an advertisement that contains a pass code that subsequently must be entered by the user to gain access additional network resources on the web site. Accordingly, the user will be required to provide a level of attention to the advertisement before receiving the desired network resources.

To inhibit use of automatic pass code entry functions, the pass code that is presented in each instance of the advertisement can be dynamically generated. In addition, if the advertisement is blocked from being presented, for example by a pop-up blocker, the advertisement can be presented in a different form. For instance, the current view can be updated with the advertisement information. One or more event logs can be maintained to provide statistics relating to the number of times and the frequency that a particular advertisement has been viewed.

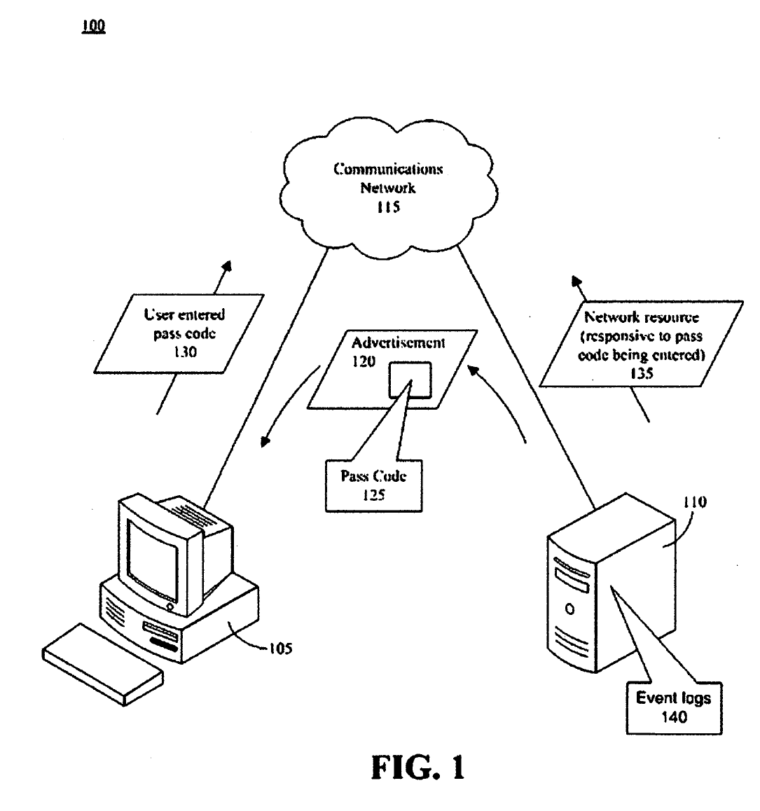

FIG. 1 is a block diagram illustrating a system 100 for presenting Internet based advertisements in accordance with one embodiment of the present invention. The system can include a client 105 that is communicatively linked to a server 110 via a communications network 115. The communications network 115 can include the Internet, a wide area network (WLAN), a local area network (LAN), a telecommunications network, a cellular communications network, and/or any other communications network suitable for propagating network resources.

The client 105 can be a computer, a personal digital assistant (PDA), a mobile communication device (e.g. a mobile telephone), an internet appliance, a telephone, or any other device that can present to the user network resources, such as web content, that is received over the communications network 115. The server 110 can be any device or system that provides network resources via the communications network 115. The server 110 can be realized in hardware, software, or a combination of hardware and software. The server 110 also can be realized in a centralized fashion in one processing system or in a distributed fashion where different elements are spread across several interconnected processing systems.

In operation, the client 105 can send a message to the server 110 requesting network resources identified by a particular uniform resource identifier (URI) associated with the server 110. For example, a user can enter the URI into a web browser on the client 105. In response, the server 110 can establish a user session and forward to the client 105 network recourses containing an advertisement 120 having a pass code 125. The advertisement 120 can include a banner ad, a sponsor logo, an interstitials, an advertorial, advertainment, 3-D visualization, and audio message, or any other advertisement that can be presented via the client 110. The advertisement can be formatted as hypertext markup language (HTML), as a scripting language, as a Java applet, an ActiveX control, a Flash file, an audio file, a multimedia file, or in any other format suitable for presentation on the client 105.

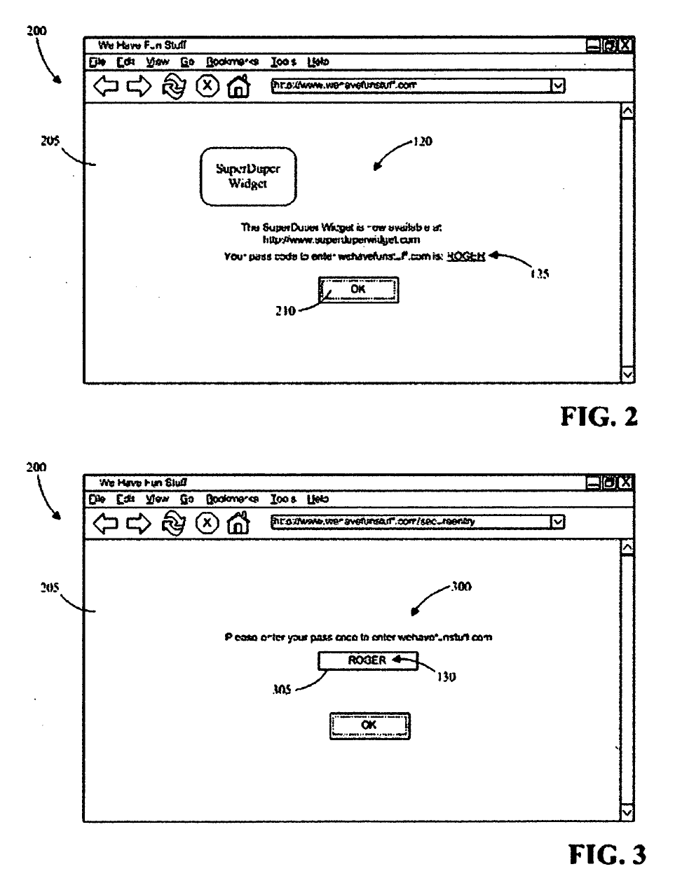

The advertisement 120 can be presented using the client's web browser in any suitable manner. For instance, the advertisement 120 can be presented graphically, audibly, or as multimedia. One example of a suitable web browser 200 is shown in FIG. 2. Nonetheless, there are a myriad of web browsers known to the skilled artisan and the invention is not limited in this regard. If the advertisement includes visual images, the advertisement 120 can be displayed in a main view 205 of the browser 200. In an alternative arrangement, a new browser window, or pop-up, can be instantiated to present the advertisement 120. If the advertisement 120 includes audio or multimedia information, such information also can be presented using the browser 200, or presented using a separate audio/multimedia player.

As noted, the advertisement 120 can include the pass code 125. The pass code 125 can be unique to a particular URI, a particular advertisement and/or a particular advertiser. In one embodiment, the pass code 125 can be dynamically generated for each advertisement instance. This can inhibit the use of automatic pass code entry functions. A record of each dynamically generated pass code 125 can be generated to associate that pass code with the particular URI, a particular advertisement and/or a particular advertiser. Since a dynamic process may sometimes repeat certain terms, additional information, such as user session information, also can be stored with the record to facilitate association of the pass code 125 with the advertisement 120.

In the example shown in FIG. 2, the pass code 125 is presented as text. Nonetheless, the pass code 125 can be presented in any other suitable manner. For example, the pass code can be presented as one or more numbers, graphical symbols and/or any other form that can be interpreted by the user. In one arrangement, the pass code can be presented as symbols that can be interpreted by the user, but which are difficult to interpret using an automated process. Use of such symbols is known to the skilled artisan. In yet another arrangement, the pass code can be presented as audio, for example using text-to-speech (TTS) synthesis. Still, other methods can be used to indicate the pass code 125. For example, the user can be prompted to identify a specific feature of the advertisement 120, such as feature in a multimedia presentation (e.g. a color of a shirt, a facial expression, an event occurring in the background of the presentation, a sound byte, etc.).

After the pass code 125 has been presented to the user, the user can choose to proceed beyond the advertisement. For example, the user can select a hyperlink or a control, such as the OK button 215. In response, a new view 300 can be presented in the browser 200, an example of which is shown in FIG. 3. The view 300 can prompt the user to enter the pass code using text, a spoken utterance, curser selections, or in any other suitable manner. For example, if the pass code was presented as text or as a graphic, a text entry field 305 can be presented to the user to prompt the user to enter the pass code 130 as text. The text entry field 305 can use a GET/POST method, or a similar method, to facilitate validation of the pass code 130 by the server 110. In another arrangement, the user can be presented a menu of selectable pass codes from which to choose the pass code 130, for instance by selecting a radio button. In yet another arrangement, the user can be prompted to utter the entire pass code 130 or a portion of the pass code 130. Such a prompt can be provided in lieu of, or in addition to, the text entry field 305. Speech recognition can be performed on the spoken utterance to generate data that can be used for the validation.

Notably, presenting the pass code 125 within the advertisement and requiring the user to enter a matching pass code 130 will generally cause the user to provide a greater level of attention to the advertisement 120 in comparison to advertisements of the prior art. Correspondingly, user comprehension of the advertisement 120 also will be greater.

Referring again to FIG. 1, the pass code 130 entered by the user can be propagated from the client 105 to the server 110 via the communications network 115. To validate the pass code 130, the pass code 130 can be compared to the pass code 125. In an arrangement in which the user entered the pass code 130 as a spoken utterance, speech recognition can be performed on the client 105 or on the server 110 to generate data that can be used for the comparison. For example, the spoken utterance can be converted to text on the client 105 and the text can be transmitted to the server 110, or the spoken utterance can be digitally encoded by the client 105 and transmitted 110 to the server as audio data. In this arrangement, the server 110 can perform the speech recognition on the audio data at the time of, or prior to, the comparison.

If the pass code 130 entered by the user matches the pass code 125, the server 110 can forward network resources 135 to the client 105. The network resources 135 can be user desired web content corresponding to the URI previously entered by the user. If the pass code 130 does not match the pass code 125, the server 110 can send a message to the client 105 prompting the user to reenter the pass code, or the advertisement 120 can be re-sent to the client.

In one arrangement, the advertisement 120 can be re-sent in a format different than the format in which the advertisement 120 was originally sent. For example, if the advertisement 120 was originally sent as a flash file or formatted for display in a pop-up window, the re-sent advertisement can be sent as HTML that is presented in the original view of the browser. This process can circumvent pop-up blockers that may be preventing the advertisement 120 from being viewed. After a certain number of attempts by the user to enter the correct pass code, or a timeout of a session timer, the server 110 can provide access to the desired content.

If the user chooses to receive additional network resource, the user can enter a URI or select a hyperlink corresponding to the additional network resources. In one arrangement, the process described above can repeat and a new advertisement can be forwarded to the client 105. In another arrangement, the user can be provided access to the additional network resources without being required to enter any additional pass codes. Session tracking or similar processes can be used to maintain session affinity between the client 105 and the server 110. For example, session cookies or begotten post requests can be implemented to maintain session affinity. A begotten post request can utilize a persistent data store during the session to store session information without the use of cookies. For example, the session identifier (sessionlD) can be held in a uniform resource locator (URL). Other session information also can be held in this manner.

The server can maintain event logs 140 to track the number of times particular advertisements are presented to users, the number of times a correct pass code is entered in response to the advertisements, and/or track any other information relative to the processes described herein. This information can be used to evaluate the exposure that a particular advertisement receives. In addition, this information can be used for generating revenue. For instance, log entries can be used to generate billing statements. An advertiser can be billed a first amount of money each time their advertisement is sent to a client and a second amount of money each time a successful pass code 130 is entered in response to an advertisement. Still, other revenue models can be implemented and the invention is not limited in this regards.

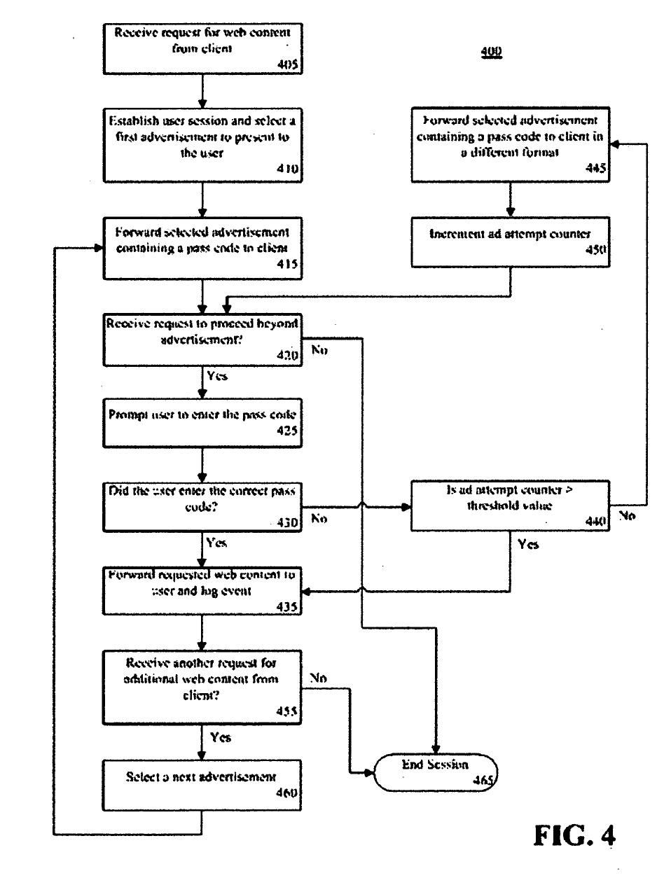

FIG. 4 is a flowchart illustrating a method 400 of presenting Internet advertisements in accordance with the inventive arrangements disclosed herein. Beginning at step 405, the server can receive a request for network resources from the client. At step 410 the server can establish a user session and select a first advertisement to present to the user. At step 415, the server can forward to the client the selected advertisement. As noted, the advertisement can include a pass code.

Referring to decision box 420 and step 425, if the server receives a request from the client to proceed beyond the advertisement, the server can prompt the user to enter the pass code. If not, the server can end the session as shown in step 465, for example after a timeout of a session timer. Proceeding to decision box 430, if the user enters the correct pass code, the requested network resources can be forwarded to the client and the event can be logged, as shown in step 435.

If the user does not enter the correct pass code, for example the user enters an incorrect pass code or no pass code is received from the client prior to expiration of an event timer, the process can continue to decision box 440. If previous attempts to resend the advertisement have been made and an ad attempt counter exceeds a threshold value, the process can proceed to step 435 where the requested network resources can be sent to the client and the event can be logged. Alternatively, the process can proceed to step 435 in response to a timeout of an event timer. Referring again to step 440, if the ad attempt counter does not exceed the threshold value (or the event timer has not timed out), the process can proceed to step 445 and the selected advertisement can be re-sent to the client in a different format. The re-sent advertisement can include a second pass code that is different than the pass code previously sent in the advertisement. At step 450, the ad attempt counter can be incremented. Continuing again to step 420, the server can receive a request to proceed beyond the advertisement and the process can repeat.

Referring to step 455, the server can receive another request from the client for additional network resources. The server then can select a next advertisement, as shown in step 460, and forward the selected advertisement along with a new pass code to the client, as shown in step 415. If a session timer times out prior to another request being received, the session can end at step 465.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a general-purpose processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway. The term “uniform resource identifier” (URI), as used herein, is an identifier of a network resource.

This invention can be embodied in other forms without departing from the spirit or essential attributes thereof. Accordingly, reference should be made to the following claims, rather than to the foregoing specification, as indicating the scope of the invention.

What is claimed is:

1. A method of advertising over a network comprising:
forwarding to a client a first advertisement comprising a first pass code, the advertisement being formatted in accordance with a first format;
prompting a user of the client to enter a second pass code corresponding to the first pass code; and
if the second pass code is received from the client and the second pass code corresponds to the first pass code, forwarding requested network resources to the client.

2. The method of claim 1, further comprising dynamically generating the first pass code in response to receiving a message from the client requesting network resources.

3. The method of claim 1, further comprising:
if the second pass code is received from the client but the second pass code does not correspond to the first pass code:
formatting the first advertisement in accordance with a second format; and
re-forwarding the first advertisement to the client.

4. The method of claim 3, wherein the re-forwarded first advertisement comprises a third pass code that is different than the first pass code.

5. The method of claim 1, further comprising:
if the second pass code is not received from the client prior to expiration of an event timer, re-forwarding the first advertisement to the client.

6. The method of claim 1, further comprising:
receiving a request from the client for additional network resources; and
forwarding a second advertisement to the client.

7. The method of claim 6 wherein the second advertisement comprises a third pass code.

8. The method of claim 1, further comprising generating a correlating log entry in response to receiving the second pass code from the client.

9. The method of claim 9, further comprising generating a billing statement using the log entry.

10. A machine readable storage, having stored thereon a computer program having a plurality of code sections comprising:
code for forwarding to a client a first advertisement comprising a first pass code, the advertisement being formatted in accordance with a first format;
code for prompting a user of the client to enter a second pass code corresponding to the first pass code and, if the second pass code is received from the client and the second pass code corresponds to the first pass code, forwarding requested network resources to the client.

11. The machine readable storage of claim 10, further comprising code for dynamically generating the first pass code in response to receiving a message from the client requesting network resources.

12. The machine readable storage of claim 10, further comprising:
code for determining if the second pass code is received from the client but the second pass code does not correspond to the first pass code and, if so, formatting the first advertisement in accordance with a second format and re-forwarding the first advertisement to the client.

13. The machine readable storage of claim 12, wherein the re-forwarded first advertisement comprises a third pass code that is different than the first pass code.

14. The machine readable storage of claim 10, further comprising code for determining if the second pass code is received from the client prior to expiration of an event timer and, if not, re-forwarding the first advertisement to the client.

15. The machine readable storage of claim 10, further comprising:
code for receiving a request from the client for additional network resources; and
code for forwarding a second advertisement to the client.

16. The machine readable storage of claim 15 wherein the second advertisement comprises a third pass code.

17. The machine readable storage of claim 10, further comprising code for generating a correlating log entry in response to receiving the second pass code from the client.

18. The machine readable storage of claim 17, further comprising code for generating a billing statement using the log entry.

19. A system for advertising over a network comprising:
a server that forwards to a client a first advertisement comprising a first pass code, the advertisement being formatted in accordance with a first format, prompts a user of the client to enter a second pass code corresponding to the first pass code and, if the second pass code is received from the client and the second pass code corresponds to the first pass code, forwards requested network resources to the client.

20. The system of claim 19, wherein the server dynamically generates the first pass code in response to receiving a message from the client requesting network resources.
